(19) United States
(12) Patent Application Publication
(10) Pub. No.: US 2011/0060668 A1
(43) Pub. Date: Mar. 10, 2011

(54) SYSTEM AND METHOD FOR GENERATING A COMBINED STATEMENT

(75) Inventors: Dominik HEIM, Hockenheim (DE); Manuel PASTORINI, Dielheim (DE); Oliver KUESTNER, Brackenheim (DE); Boris BRAUN, Eppingen (DE)

(73) Assignee: SAP AG, Walldorf (DE)

(21) Appl. No.: 12/570,675

(22) Filed: Sep. 30, 2009

Related U.S. Application Data
(60) Provisional application No. 61/239,884, filed on Sep. 4, 2009.

(51) Int. Cl. G06Q 10/00

(52) U.S. Cl. 705/34; 705/30

(57) ABSTRACT

A combined statement processing (“CSP”) system and method provides a combined statement attribute to a master contract, which defines a set of accounts for which a combined statement should be generated. The CSP may generate a number of unique tokens passed on a pre-existing output management system (“OMS”). The unique tokens may also be passed to a set of account management systems (“AMS”), which may trigger various reports to the OMS by the AMSs. Using the unique tokens sent by the CSP, the OMS may then hold the output production until reporting data is received by the AMSs from each unique token. This way, a pre-existing OMS and pre-existing AMSs may be leveraged to with little or no alteration to generate a combined statement.

This application claims the benefit of U.S. Provisional Patent Application Ser. No. 61/239,884 filed on Sep. 4, 2009, the entire contents of which are incorporated herein by reference.

### BACKGROUND

Modern organizations use computer systems to manage their daily operation. Currently, many financial institutions (e.g., retail banks, etc.) use Account Managing Systems (“AMS”) to organize and facilitate client accounts. AMS systems are well known and may include, for example, those available through Banking Services from SAP®. Additionally, these institutions may use an Output Management System (“OMS”) to generate statements to account holders, for example, paper statements that are mailed to account holders or electronic statements that are communicated via e-mail or other electronic communication. The OMS may operate as a “black box” service available to several AMS applications. The AMS may provide account data to the OMS, which may construct and output a customer statement for mailing. This requires an individual statement for each account. Conventional OMS applications may provide limited merging functions. For example, if two AMS data sets reach the OMS with the same address and customer name, the OMS may or may not combine them into one mailing. There is currently no way to trigger a combined data transmission from multiple AMS applications to the OMS, and no way to ensure the OMS collects all of the related data before creating a combined statement.

A combined statement would be beneficial as a cost savings measure (e.g., paper and postage), as well as providing a more customer-friendly organization to multiple account statements. Because of the complexity of financial enterprise systems, re-designing the AMS and OMS from scratch to include this functionality would be extremely expensive. Additionally, each system may be provided by a different company, making a collaborative redesign even more difficult. Thus, there exists a need to provide combined statement functionality, while leveraging existing components with little or no change to those components.

### BRIEF DESCRIPTION OF THE DRAWINGS

FIG. 1A illustrates a computer system according to an embodiment of the present invention.

FIG. 1B illustrates processes performed by an embodiment of the present invention.

FIG. 2A illustrates processes performed by an embodiment of the present invention.

FIG. 2B illustrates further processes performed by an embodiment of the present invention.

FIG. 3 illustrates an example master contract data structure, according to one embodiment of the present invention.

FIG. 4 illustrates an example combined report, according to one embodiment of the present invention.

FIG. 5 illustrates a structural flow diagram, according to another embodiment of the present invention.

### DETAILED DESCRIPTION

A combined statement (also known as consolidated statement) is a medium for communicating statement details of multiple bank accounts in an integrated way. Example embodiments of the present invention include systems and methods for constructing a combined statement while leveraging existing statement tools.

As a result, bank customers may periodically receive one combined statement showing all deposit and loan accounts, credit card accounts, and other bank products with their related transactions, rather than receiving numerous bank statements—each for a single account—and so take advantage of joint information.

The proposed invention includes a combined statement processing component that interfaces with the various AMS and the OMS. Example embodiments of the proposed invention leave the OMS unaltered, fully leveraging its existing functionality while avoiding any complexities of altering the OMS architecture. Further, example embodiments require minimal alteration to the remaining data structures.

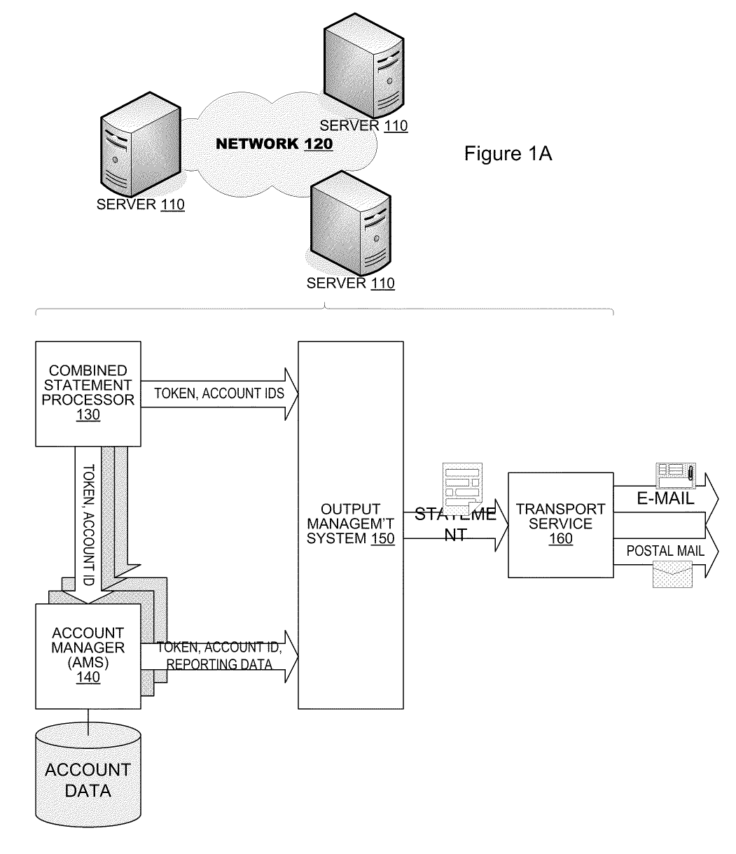

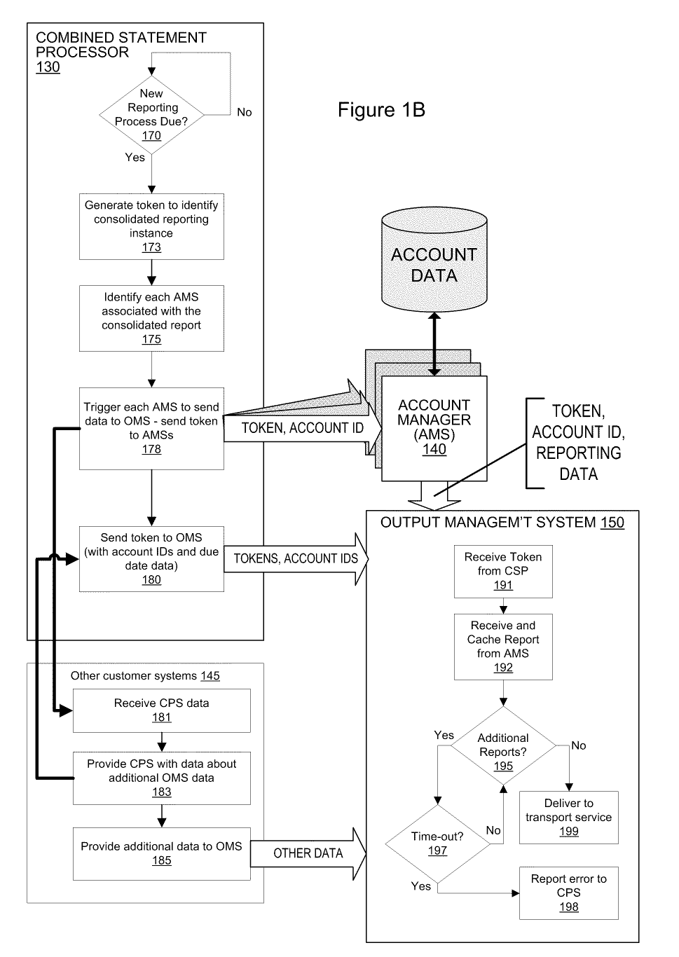

FIG. 1A illustrates one example embodiment of the present invention. The system may include a plurality of computer servers 110 interconnected via a network 120. The system may instantiate several software systems according to program instructions. For example, a Combined Statement Processor (“CSP”) 130 may be instantiated, which may be in communication with an Output Management System (OMS) 150 and a plurality of Account Managing Systems (AMS) 140. The CSP may engage a combined statement reporting process. As it does so, it may exchange messages with the AMSs and the OMS, providing a token that uniquely identifies an instance of the reporting process. The CPS may identify account(s) to each AMS and to the OMS that are to be reported out pursuant to the process. The AMSs may retrieve data from their managed accounts and provide them to the OMS. Once the OMS has received data from the AMSs for all accounts identified in the message the OMS received from the CSP, it may generate a combined statement.

The CSP 130 may store a master data object identifying accounts from the AMSs that are subject to the common reporting technique of the present invention. The CSP 130 may engage a reporting operation and generate a unique token for the reporting operation. The CSP 130 may also provide the AMSs with account due dates (e.g., a range from a first date to a second date). This way, the master contract data object may store the periodicity information, and the AMSs do not need to maintain that information.

The example system may instantiate one or more AMS systems 140 that may manage individual accounts for account holders. The set of Account Management Systems may be provided by separate vendors, and may consequently not be tightly integrated modules. Some AMSs may be established for various account types (e.g., credit cards, checking accounts, interest bearing accounts, restricted accounts (e.g., Certificates of Deposit)), while other AMS variations may arise from originating with different vendors and software designers. Thus, the AMS may maintain one or more accounts and/or account types, and have a standard or at least known application programming interface (API). Additionally, the example system may be in communication with various AMSs provided outside the system. Each AMS may exchange messages with other components, including the OMS and CSP, but otherwise may maintain the management functions for accounts autonomously, according to their own design.

The AMS systems 140 may receive tokens and account IDs from the CSP 130 to engage the consolidated reporting process of the present invention. The AMS systems 140 may store account data representing the accounts that they manage according to their programming. The AMS systems 140 may retrieve account reporting data from its native databases and communicate the data to the OMS 150 along with the token provided by the CSP 130. In example embodiments where the master contract stored at the CSP 130 includes the definition of the periodicity of one or more accounts, the CSP 130 may transmit the relevant dates to the AMSs, which may forward the specified data, along with the unique token provided by the CSP 130.

The example system may include an instantiation of the Output Management System (OMS) 150 that may provide statement reporting. The OMS may receive account data from a variety of AMSs and may produce account statements from the account data. The OMS 150 may receive a token and account IDs from the CSP, identifying accounts that are subject to the consolidated reporting process. The OMS may also receive due dates from the CSP identifying the current period of the combined statement. The OMS 150 may also receive communications from the AMSs that may include: a token identifying a reporting instance to which the communication corresponds, an account ID, and the reporting data to be included in the consolidated statement. The OMS 150 may cache reports from the AMSs until it determines that it has received reports for all accounts that are subject to a particular consolidated report. After the OMS 150 determines that is has received AMS reports for all accounts identified in the CSP 130 communication, it may generate a consolidated report. The different AMSs 140 or different sets of the AMSs 140 may be operated by a different financial institutions, but may maintain a substantially uniform interface with the shared OMS 150.

The OMS 150 may be provided in communication with the CSP 130. An example embodiment of the present invention may leverage the OMS system 150 in unaltered form to create combined statements. A standard OMS design may provide various functions, including accepting combined statement requests from Master Contract Management systems and accepting account-level statement records from account-managing systems. The OMS may combine data provided from different sources, such as cross-account information (e.g. combined statement master data, recipient information of the combined statement) and information from account-managing systems. The OMS may define business rules for handling error situations such as information from single sources not being provided in time (e.g., for one account) and provide functionality to perform the error handling. The OMS may handle formatting and layout requirements, receiving the raw data and providing the final form of the statement layout.

The example system of FIG. 1A may including, in communication with the OMS 150, a transport service 160, e.g., as part of the OMS 150 or a separate transport server. The transport service 160 represents a transport mechanism to deliver statements to account holders. The transport service may include electronic transport services (such as an e-mail server for e-mailed reports). Alternatively, the transport service 160 may include printers and automated mailers for postal transport services for paper reports.

FIG. 1B illustrates one example embodiment of an example process for the operation of an example system. The CSP 130 may determine at 170, with reference to a master data object, when a new reporting process is to begin. As noted, the master data object may store data identifying accounts that are subject to a consolidated report and data indicating when reports are to be generated, referred to as the periodicity of the combined statement (for example, monthly on the 1^{st} of each month). At 173, the CSP 130 may generate a token that uniquely identifies the instance of consolidated reporting that is to begin. At 175, the CSP 130 may identify the AMS system(s) 140 and the accounts therein that are subject to the consolidated reporting instance. At 178, the CSP 130 may communicate commands to the AMS systems identified above to trigger reporting. The commands may include a token and the account IDs. At 180, the CSP 130 further may communicate a command to the OMS 150 identifying the consolidated reporting instance, which may include the token and the account IDs of the AMS systems.

The AMSs 140 may engage reporting processes according to their own designs. Each AMS 140 may deliver reports to the OMS which include the token provided by the CSP 130, account IDs of the account(s) being reported and substantive data to be included in the consolidated statement. The CSP 130 may also provide other outside systems 145 to have access to the OMS and combined statement. For example, the CSP 130 may send data to the outside system 145 about one or more accounts that are due, e.g., at 181. The outside system 145 may then determine if additional information should be included in the combined statement (e.g., an advertisement). If the data received by the CSP 130 indicates additional data should be included, the outside system 145 may send back that indication, e.g., at 183. Now, in addition to the tokens representing the expected AMS data, the CSP 130 may additionally create and transmit to the OMS tokens representing expected data from the other customer system 145. This may allow the OMS to not only wait for all of the AMS data, but to also wait for specified data from one or more outside systems 145. That other data may be provided at 185.

An example OMS 150 operation is also shown in FIG. 1B. The OMS 150 may be provided in the overall system (e.g., FIG. 1A), or may be wholly separate from the CSP 130. The OMS 150 may receive the token/data from the CSP 130, e.g., at 191. The OMS 150 may receive the reports from the AMSs 140, e.g., at 192. The OMS 150 may cache the report data in association with tokens until reports are received for all accounts identified in the CSP 130 communication, e.g., at 192 and 195. The OMS 150 may have a time-out procedure, e.g., at 197, and may inform the CSP 130 if one or more expected reports were not received, e.g., at 198. The OMS 150 may generate a consolidated statement and deliver it to a transport service 160, e.g., at 199. The OMS 150 may also include any number of other features, such as other error-handling features.

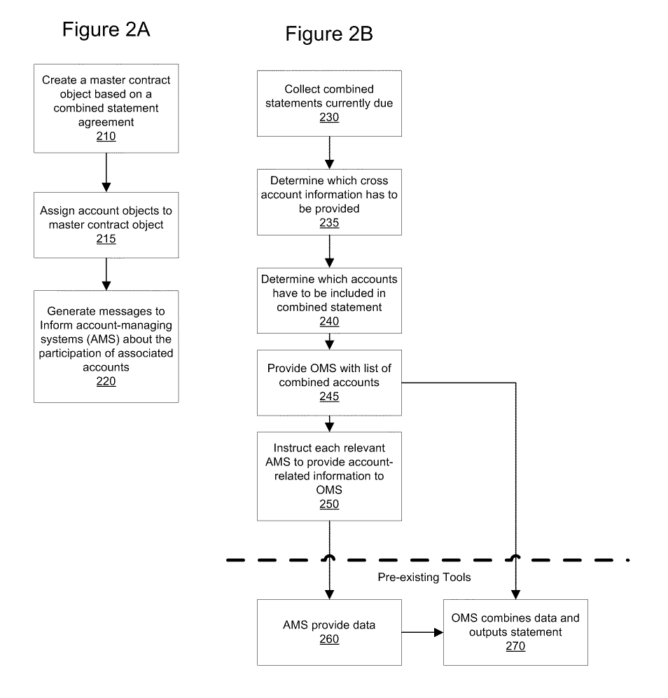

FIG. 2A illustrates one example embodiment of a process for setting up the combined statement framework. A combined statement agreement may exist between any relevant parties (e.g., the owner of the accounts, and the providers of the accounts). Further, one or more due dates (e.g., periodicity) may have been established for the combined statement. At 210, a master contract object, based on the combined statement agreement, may be created and may control the combined statement initiation process. Next, at 215, several accounts may be assigned to the master contract object. This may be facilitated by adding a combined statement relation to a pre-existing “Master Contract” object. This relation may link each account belonging to a specific combined statement. The Master Contract Object may also have a new field added to its attributes, which identifies the particular Master Contract with a particular combined statement (e.g., an abstract instance of a particular combined statement, from which a plurality of unique statement IDs may be created, one for each occurrence of a defined periodicity). Next, at 220, each affected AMS may be informed that one or more accounts it manages is part of a new combined statement.

FIG. 2B illustrates one example embodiment of a process for generating a combined statement. First, at 230, each combined statement that is currently due is collected/identified, and the subsequent steps may be performed for each of those combined statements. The combined statement system may operate on-demand, e.g., via a user request for a specific statement or set of statements, and/or as a mass-run system, e.g., periodically printing all known statements that are due. Next, at 235, the master contract identifies cross-account data, such as the name and address of the account holder. This data may be sent to the OMS to be added to the combined statement output. Next, at 240, statements that are part of the combined statement are identified for inclusion in the current combined statement, which may be all associated statements or some subset. A combined statement process may alternatively print all statements that belong to a combined statement at any due date, or only certain statements for a particular due date.

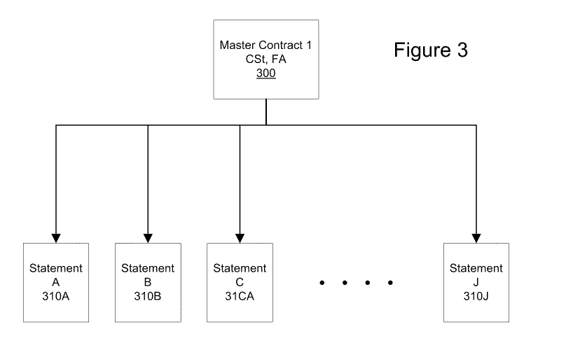

FIG. 3 illustrates an example Master Contract “#1” 300 with associated accounts A to J. The Master Contract object is illustrated with the added relation of associated accounts included in a combined statement. Additionally, an identifier field may be added (e.g., CSt, combined statement identifier). Next, at 245, the example process may provide the OMS with a list of accounts to expect data from. For example, if account A, B, D, and J were to be included in a combined statement, the example method may inform the OMS that it should wait for data chunks from A, B, D, and J. Each data chunk may have a token unique to its account and to its run (e.g., such that a first period for a first account has a unique token compared to a second period for the first account or a first period for a second account). This way, if there is an error or the OMS otherwise gets backlogged, the system can still determine which data belongs to which statement for which reporting period. The example method may also send over cross-account data for inclusion in the output.

Next, at 250, the example process may trigger each relevant AMS to provide its information to the OMS for output. At 260, each AMS may provide account data to the OMS, and at 270 the OMS may combine the data and output the statement. The OMS may function unaltered, leveraging the preexisting tool by providing a different kind of input (e.g., from the combined statement processing component and example process). Each AMS may function unaltered, or alternatively, may have an added field to point back to an associated master contract. This added field may allow an AMS to initiate a combined statement by informing the combined statement processor, via the associated master contract, that at least one account of that master contract is due to be printed.

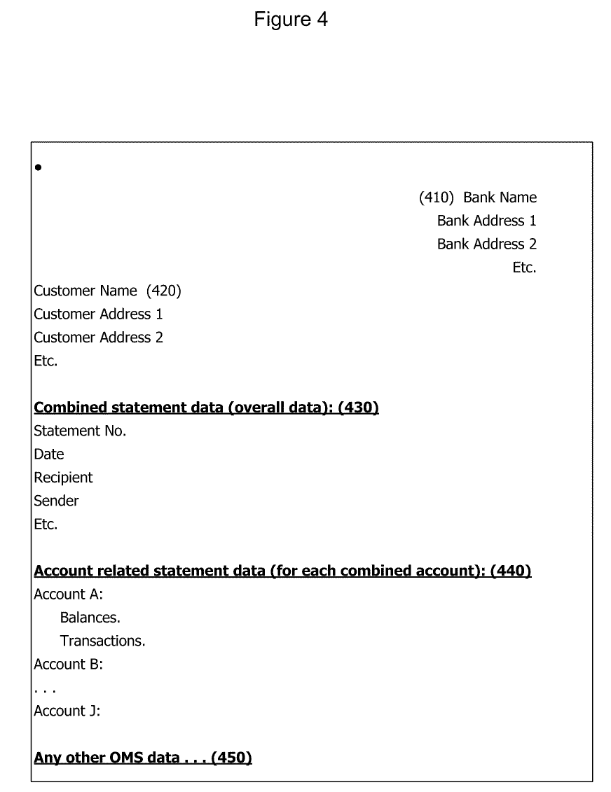

FIG. 4 illustrates one example embodiment of a combined statement. Area 410 may include the issuer information. This may be a clearinghouse institution for all of the accounts, the master contract organizer, the bank associated with an account that caused the combined statement to print (e.g., via a due-date), or any other sender information relevant to the issued statement. Area 420 may include the cross-account information, e.g., the information shared by the various combined accounts, such as customer name, address, etc. Area 430 may include additional cross-account information, and combined statement specific information, such as statement number, master contract identifier, etc. Area 440 may include the various combined accounts and their associated account data. This area may also include other data provided by an AMS. Area 450 optionally includes any other OMS data, such as legal disclaimers, notices, forms, etc.

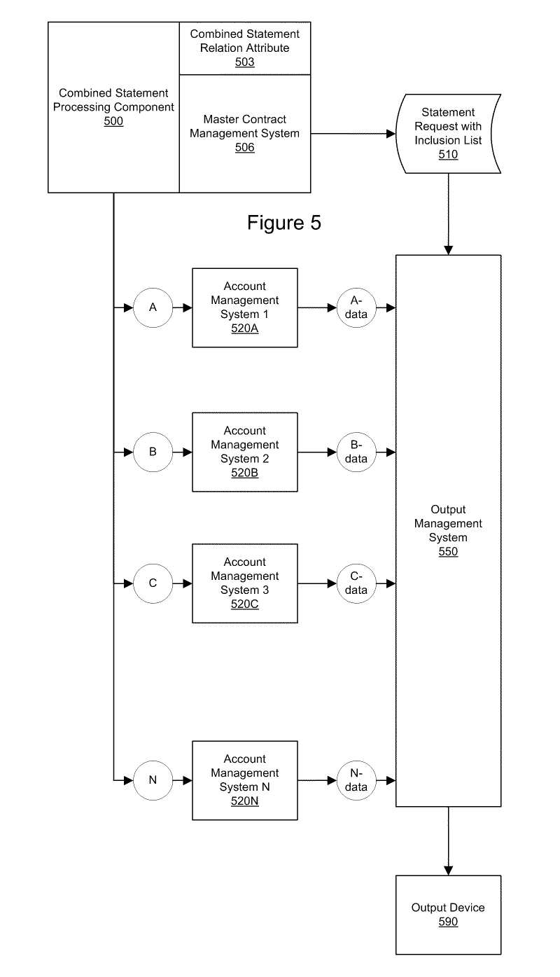

FIG. 5 illustrates another example embodiment of the basic block diagram, illustrating an example component organization of an example combined statement process/system. The example system illustrated in FIG. 5 may include a combined statement processing component 500. This component may be part of or in communication with the master contract management system 506, including the added combined statement relation attribute 503. When one or more accounts come due, (e.g., as defined by the periodicity of each account), the master contract management system 506 may use the account relations 503 to identify each account that is required for the combined statement. The periodicity may include any number of days, weeks, months or years as a frequency. The periodicity may include a start date for the statement from which the future statement due dates are determined. The periodicity may include rules for handling different types of days upon which a due date may fall. These working day rules may define what happens to the next execution date if it falls on a day that is not a working day, according to the calendar assigned to the master contract. Different calendars may be assigned to the master contract, such that different holiday schedules may trigger the working day rules. The example system may support various options, such as no shift, shift to next working day, modified shift to next working day, shift to previous working day, or modified shift to previous working day. Modified shift may mean that the combined statement determination cannot be shifted to a month other than the month in which the invalid date fell.

A data packet 510 may be sent to the OMS 550, including cross-account data and a list of accounts that will form part of the output. This may be accomplished by sending the OMS a set of token identifiers that will also be sent to the individual accounts. The combined statement processing component 510 may trigger each relevant AMS to send data to the OMS, and may send a unique token to each relevant account, e.g., A, B, C, . . . and N. The AMS may then pass along the unique token (e.g., A to N) in combination to the data required by the OMS for the individual account (e.g., A-data to N-data). The OMS, may collect the required data, format it, add the cross-account data, add any other standard data, and send the finished statement to the output device 590 (e.g., a mass-emailing server and/or a mass-print-mail machine). The OMS may also issue error codes back to the combined statement processing component. For example, if the OMS is told data tokens A, B, F and J are to be output, and only tokens A, B, and J arrive after a pre-set timeframe, the OMS may issue a time-out error to instruct the administrator that something is wrong and token F never arrived. Alternatively, errors may be handled inside the OMS, including any time-out errors. In this embodiment, other components may be able to pull error indicators from the OMS to use in other contexts, while the OMS directly deals with the error resolution. For example, FIG. 1B (198) may alternatively do the actual error handling for the example system and process.

With example embodiments of the combined statement system a locking functionality is possible to stop a business process on a contract for a certain period of time. In the case of bank statements or combined statements, a reason for not executing a statement upfront may be that it is known that data needs to be corrected (e.g., financial conditions, settlement results) before this data is communicated to the customer. To stop the creation of combined statements, temporary locking functionality may be required. When an account is locked there may be no need to create a trigger or unique ID, but instead the cross-account information may include information about the locked status of the account to be printed on the combined statement.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

1. A method of creating a combined reporting statement, comprising:
storing a master contract data object on a combined statement computer system, wherein the master contract data object includes a defined periodicity;
responsive to occurrence of the defined periodicity:
generating on the combined statement computer system a unique consolidated statement token that indicates a plurality of accounts to be included in a consolidated statement;
generating on the combined statement computer system a unique triggering token for each account management system responsible for an account in the plurality of accounts to be included in the consolidated statement;
sending the unique consolidated statement token to an output management system configured to receive the unique consolidated statement token and generate a consolidated statement including reporting data from each account source indicated in the unique consolidated statement token; and
sending the unique triggering token to each respective account management system.

2. The method of claim 1, further comprising:
receiving a time-out error from the output management system when the output management system does not receive reporting data from each indicated account source within a pre-defined time period.

3. The method of claim 1, further comprising:
including in the unique consolidated statement token an indication of an other data source other than an account management system.

4. The method of claim 3, further comprising:
sending data related to the plurality of accounts to the other data source; and
receiving data related to other data being provided to the output management system.

5. The method of claim 1, wherein the unique consolidated statement token is uniquely generated for each occurrence of the defined periodicity.

6. The method of claim 1, wherein the master contract data object defines cross-account information that includes one of: customer name and customer address.

7. The method of claim 1, further comprising:
storing a working-day rule that modifies a due date defined by the periodicity when the due date falls on a non-working-day, as defined by the working-day rule.

8. The method of claim 1, further comprising:
receiving from the output management system an error message including the unique consolidated statement token.

9. A system for creating a combined reporting statement, comprising:
a combined statement computer system for instantiating a master contract data object, wherein the master contract data object includes a defined periodicity;
the combined statement computer system configured to, responsive to occurrence of the defined periodicity:
generate a unique consolidated statement token that indicates a plurality of accounts to be included in a consolidated statement;
generate a unique triggering token for each account management system responsible for an account in the plurality of accounts to be included in the consolidated statement;
send the unique consolidated statement token to an output management system configured to receive the unique consolidated statement token and generate a consolidated statement including reporting data from each account source indicated in the unique consolidated statement token; and
send the unique triggering token to each respective account management system.

10. The system of claim 9, further configured to:
receive a time-out error from the output management system when the output management system does not receive reporting data from each indicated account source within a pre-defined time period.

11. The system of claim 9, further configured to:
include in the unique consolidated statement token an indication of an other data source other than an account management system.

12. The system of claim 11, further configured to:
send data related to the plurality of accounts to the other data source; and
receive data related to other data being provided to the output management system.

13. The system of claim 9, wherein the unique consolidated statement token is uniquely generated for each occurrence of the defined periodicity.

14. The system of claim 9, wherein the master contract data object includes cross-account information that includes one of: customer name and customer address.

15. The system of claim 9, further configured to:
store a working-day rule that modifies a due date defined by the periodicity when the due date falls on a non-working-day, as defined by the working-day rule.

16. The system of claim 9, further configured to:
receive from the output management system an error message including the unique consolidated statement token.

17. A computer-readable storage medium encoded with instructions configured to be executed by a processor, the instructions which, when executed by the processor, cause the performance of a method, comprising:
storing a master contract data object on a combined statement computer system, wherein the master contract data object includes a defined periodicity;
responsive to occurrence of the defined periodicity:
generating on the combined statement computer system a unique consolidated statement token that indicates a plurality of accounts to be included in a consolidated statement;
generating on the combined statement computer system a unique triggering token for each account management system responsible for an account in the plurality of accounts to be included in the consolidated statement;
sending the unique consolidated statement token to an output management system configured to receive the unique consolidated statement token and generate a consolidated statement including reporting data from each account source indicated in the unique consolidated statement token; and
sending the unique triggering token to each respective account management system.

18. The computer-readable storage medium of claim 17, the method further comprising:
including in the unique consolidated statement token an indication of an other data source other than an account management system.

19. The computer-readable storage medium of claim 18, the method further comprising:
sending data related to the plurality of accounts to the other data source; and
receiving data related to other data being provided to the output management system.

20. The computer-readable storage medium of claim 17, wherein the unique consolidated statement token is uniquely generated for each occurrence of the defined periodicity.
